(19) United States
(12) Patent Application Publication
(10) Pub. No.: US 2017/0251482 A1
(43) Pub. Date: Aug. 31, 2017

(54) INTERFERENCE MITIGATION/AVOIDANCE

(71) Applicant: KABUSHIKI KAISHA TOSHIBA, Tokyo (JP)

(72) Inventors: Woon Hau CHIN, Bristol (GB); Hirokazu TANAKA, Tokyo (JP)

(73) Assignee: KABUSHIKI KAISHA TOSHIBA, Tokyo (JP)

(21) Appl. No.: 15/509,400

(22) PCT Filed: Mar. 20, 2015
(86) PCT No.: PCT/GB2015/050833

§ 371 Date: Mar. 7, 2017

(51) Int. Cl. H04W 72/08; H04B 17/336; H04B 13/00

(52) U.S. Cl. CPC H04W 72/082; H04B 13/005; H04B 17/336

(57) ABSTRACT

An approach for interference mitigation/avoidance in a first wireless network, for example a Body Area Network (BAN), uses signals from other BANs to adjust data transmissions by the first network.

### FIELD

This disclosure relates to interference mitigation/avoidance. In particular, but without limitation, this disclosure relates to the mitigation/avoidance of interference between different wireless networks, for example wireless Body Area Networks (BANs).

### BACKGROUND

BANs consist of wireless nodes attached to different parts of a body in order to perform certain functions, such as monitoring the vital signs of the body. BANs usually operate in the Industrial, Scientific, and Medical (ISM) frequency bands—such bands can be very crowded and so changes in the radio environment can cause interference—for example from other BANs or from other devices utilising the same ISM band.

To deal with inter-BAN interference, communication between BANs can be coordinated—for example, as described in the IEEE 802.15.6 where, by communicating amongst themselves, neighbouring BANs can interleave their superframes so as to coexist on the same data channel.

### SUMMARY

Aspects and features of the invention are set out in the claims.

An effect of the approaches described herein is that interference can be mitigated without the need for coordination between BANs. This reduces signalling overheads and therefore reduces the energy consumption required for interference mitigation/avoidance. Furthermore, the approaches described herein enable multiple wireless networks to operate in close proximity to each other and the approaches can be performed passively by a single hub node—that is to say without any actions being needed to be performed by other nodes.

### BRIEF DESCRIPTION OF THE DRAWINGS

Examples of the present disclosure will now be described with reference to the accompanying drawings in which:

FIG. 1 shows a plurality of networks within which the described approach may be employed;

FIG. 2 shows the structure of an illustrative data channel;

FIG. 3 shows a wireless device incorporating the wireless receiving module of FIG. 1;

FIG. 4 shows a flowchart of the steps of a method described herein;

FIG. 5 shows an illustrative representation of active and inactive periods for two hubs; and

FIG. 6 shows an example MAC frame body for a C-Beacon and the components thereof.

### DETAILED DESCRIPTION

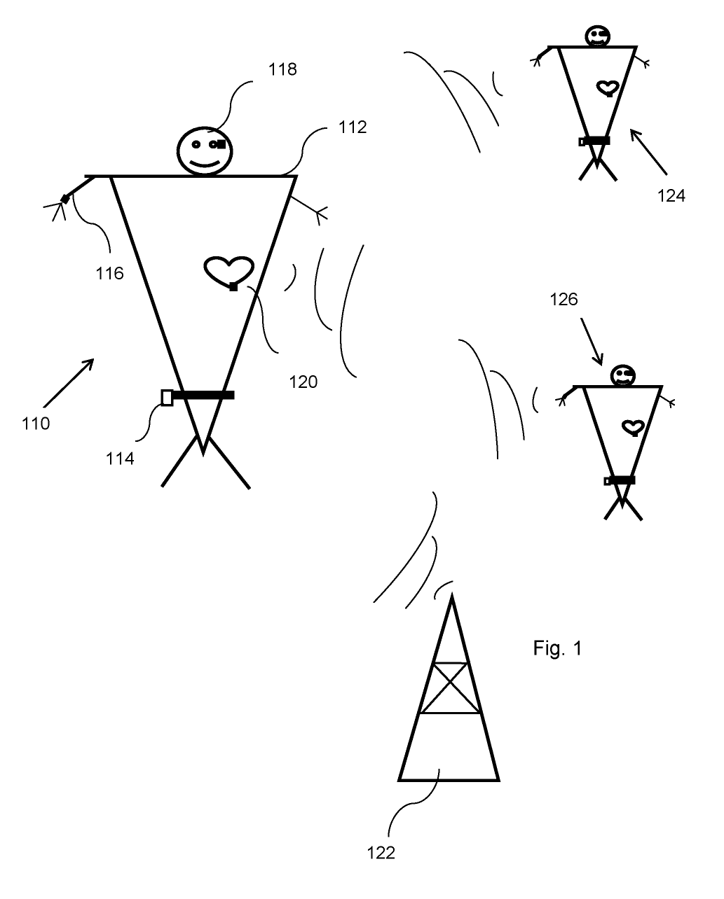

FIG. 1 shows a first wireless network 110 (in this case a BAN) being worn on a subject 112 and comprising a wireless hub node 114 and a plurality of wireless peripheral nodes 116, 118, 120. In this example, the peripheral nodes 116, 118, 120 are respectively positioned on the subject's wrist, so as to enable monitoring of the subject's movement, on the subject's face, so as to enable monitoring of the ocular pressure of the subject's eye or eyes, and coupled to a cardiac pacemaker device (not shown) so as to enable monitoring and control of the subject's heart. The peripheral nodes 116, 118, and 120, are arranged to wirelessly communicate with one another and/or the hub node 114. The hub node 114 may further be arranged to communicate wirelessly with a base station 122 and/or an access point (not shown). FIG. 1 also shows a second wireless body area network 124 and a third wireless body area network 126. Each of the second and third wireless body area networks 124, 126 are, like the first wireless body area network 110, arranged so that its respective hub node can communicate with the base station 122.

In the networks 110, 124, and 126, and also for the base station 122, messages are formatted and encoded by a PHysical Layer (PHY) so as to put each message into a signal appropriate for transmission on the wireless medium. Messages are also formatted and encoded by a Medium Access Control layer (MAC) which controls when a signal is sent on the wireless medium so as to minimise collisions with other signals.

In the first wireless network 110, the hub node 114 is arranged to facilitate and control the transmission of signals to and from the peripheral nodes 116, 118, and 120. The first wireless network 110 uses two channels, a Control CHannel (CCH), used by the hub node 114 to announce network parameters used by the first wireless network 110, and a Data CHannel (DCH), used by the first wireless network 110 for transmitting signals between the hub node 114 and the peripheral nodes 116, 118, 120. As an example, the CCH is used by the hub node 114 to announce network parameters, such as the DCH number, through the periodic broadcast of control beacons (C-Beacons). The CCH contains an additional field which may be described as an Interference Mitigation bit, which will be set to ‘1’ when a network is employing an interference mitigation method, and set to ‘0’ otherwise (or vice versa). The CCH may also contain a further additional field which may be described as a duty cycling field and which records the percentage of duty cycling used by the network to which the CCH pertains. Exemplary implementation values for the duty cycling field are set out in Table 1.

TABLE 1
Bit values for Duty Cycling Field

| Bit Value | Duty Cycling (%) |
|---|---|
| 00 | 0 to <25 |
| 01 | 25 to <50 |
| 10 | 50 to <75 |
| 11 | 75 to 100 |

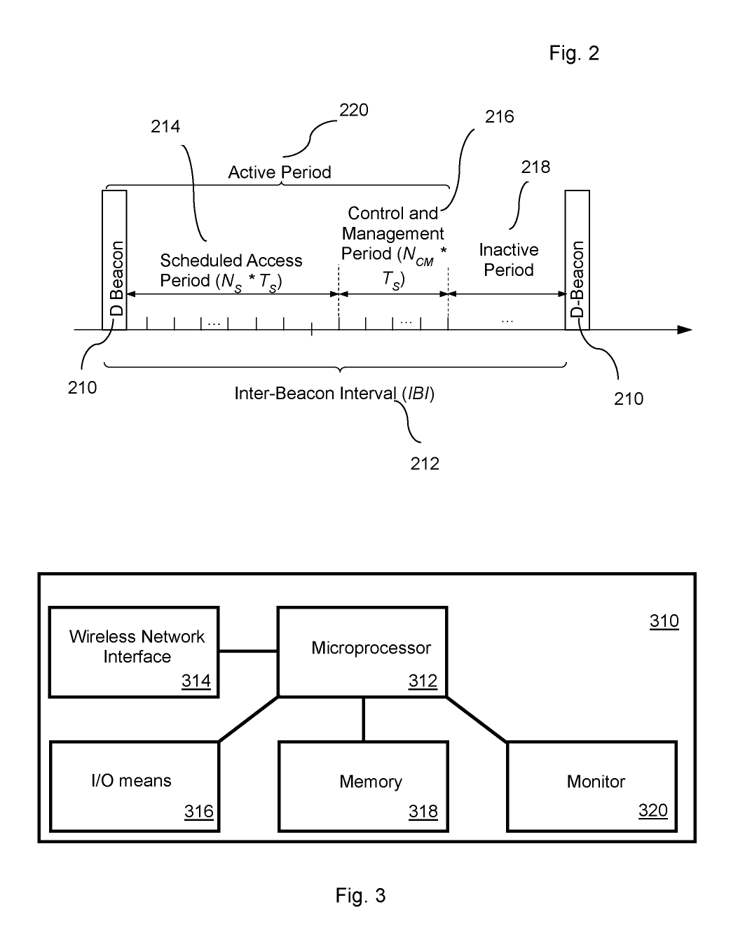

The hub node 114 facilitates the transmission of signals in the DCH through the use of Data Beacons (D-Beacon) to mark out the time boundaries during which signals can be sent. The structure of the DCH is illustrated in FIG. 2. Each D-Beacon 210 marks the beginning of a new period having a length equal to the Inter-Beacon Interval (IBI) 212. Apart from the time used for transmitting the D-Beacon itself, each period consist of three distinct sub-periods. The Scheduled Access Period 214 is where scheduled transmissions take place, while the Control and Management Period 216 is where all non-scheduled transmissions and some control signalling takes place. The Inactive Period 218 is the period where all transmissions will cease until the end of the IBI. The time period from the start of the D-Beacon 210 to the end of the Control and Management Period 216 is also known as the Active Period 220. The Duty Cycling (DC) of the transmission can be calculated as DC (%) =Active Period/IBI. As one possibility, a BAN that does not wish to coexist with another BAN in the same DCH can set its DC to 100%. Whereas the duty cycling of a BAN is usually not determined by whether it wants to coexist with another BAN, it may be determined by how much data the nodes have to transmit.

FIG. 3 shows an exemplary block diagram of the macro components of a wireless device 310-for example a hub or peripheral node. The wireless device 310 comprises a microprocessor 312 arranged to execute computer readable instructions as may be provided to the wireless device 310 via one or more of: a wireless receiving module 310 being arranged to enable the microprocessor 312 to communicate wirelessly with a network; a plurality of input/output interfaces 316 which may include one or more buttons, touch screen, a keyboard and a board connection (for example a USB connection); and a memory 318 that is arranged to be able to retrieve and provide to the microprocessor 312 instructions and data that has been stored in the memory 318. The microprocessor 312 may further be coupled to a display upon which a user interface may be displayed and further upon which the results of processing/or sensing operations may be presented.

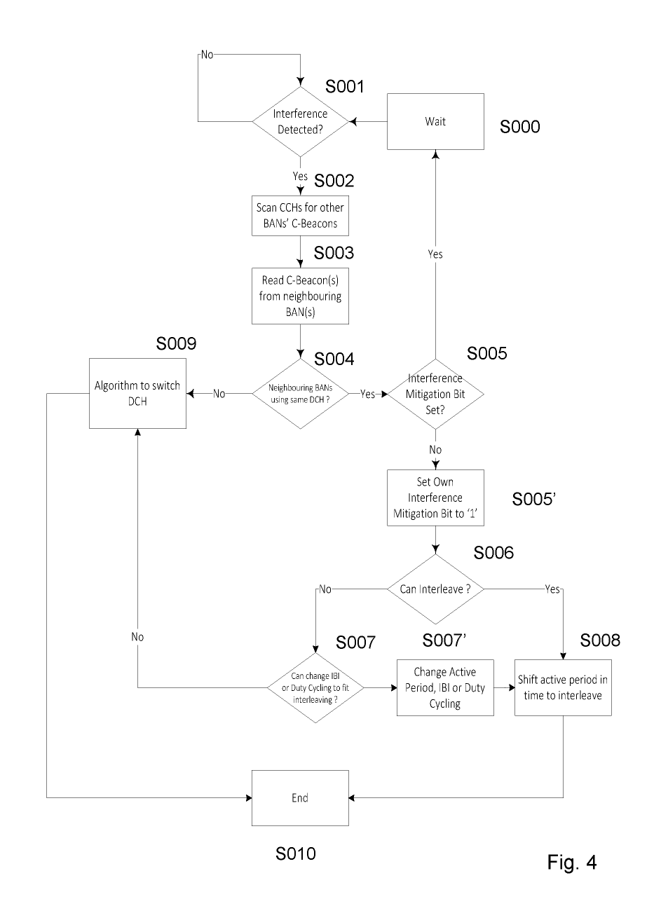

FIG. 4 shows a flowchart of the steps of a method of interference mitigation/avoidance. The interference mitigation or avoidance method starts at step S001 when a determination is made that one or more signals received in the first wireless network 110 has experienced interference. This determination can be made, for example, by evaluating performance based metrics, such as an increased Packet Error Rate (PER), or by evaluating signal strength metrics, such as a drop in Signal-to-Noise Ratio (SNR) or Received Signal Strength Indicator (RSSI), and such metrics may be evaluated and monitored for change by the hub node 114. Once such a determination has been made, the method will proceed to step S002, otherwise, the method will return to step S001.

At step S002, the hub node 114 scans the different CCHs for the presence of other C-Beacons-which would indicate the presence of neighbouring wireless networks.

At step S003, on the detection and reception of a C-Beacon for a network (i.e. a BAN) other than the first wireless network 110, the hub node 114 reads the MAC body of the received C-Beacon and extracts information about the DCH used by that other network.

At step S004, the hub node 114 checks whether the DCH used by the other network is the same as one used by the first wireless network 110. If the DCH of the other network is found to be the same as one used by the first wireless network 110, the hub node 114 extracts and records the Slot Length, Time Slot, Duty Cycling, and Interference Mitigation fields of that other network. The Slot Length and Time Slot fields can be used to calculate the IBI of the other network.

If the DCH of the other network is not found to be the same as one used by the first wireless network 110, the method proceeds to step S009. As interference has been determined to occur, but the other network is not using a DCH in common with the first wireless network, the interference is unlikely to have been caused by the DCH of the other network and so adjusting DCH parameters used by the first wireless network 110 is unlikely to mitigate/avoid the interference. Accordingly, at step S009, the hub node 114 changes the DCH used by the first wireless network 110 in an attempt to mitigate/avoid interference and the method then proceeds to end at step S010. As an example, the new DCH can either be chosen by scanning available DCHs and choosing the one with the lowest interference, or randomly choosing a DCH and activating the interference avoidance method of FIG. 4 if interference is detected.

At step S005, the hub node 114 checks to see if the CCH of the other network has an interference mitigation bit set so as to indicate that interference mitigation/avoidance is being performed for the other network. For example, when the interference mitigation bit of the other network's CCH is set to ‘1’, it means that the other network is employing an interference mitigation method. If interference mitigation/avoidance is being performed for the other network, then attempts made by the hub node 114 to mitigate/avoid interference by way of adjusting its DCH parameters could aggravate interference and so, in such cases, the method will proceed to step S000 and wait for a predetermined amount of time before starting again at step S001. Otherwise, the method proceeds to step S005′.

At step S005′, the hub node 114 sets the mitigation bit of its own CCH so that other BANs that receive the first wireless network's CCH will not simultaneously attempt to mitigate/avoid interference by way of DCH parameter variation.

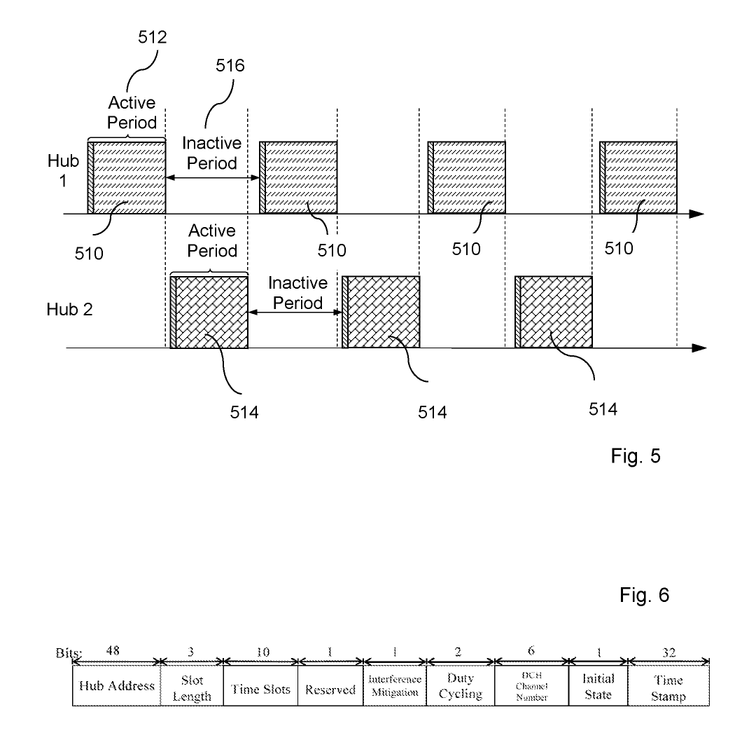

At step S006 the hub node 114 checks to see whether or not it would be possible to interleave transmissions between the first wireless network 110 and the other network(s). An example of interleaved transmissions is shown in FIG. 5 which shows DCH transmissions 510 for a first hub node during its active period 512 and DCH transmissions 514 for a second hub node during the inactive period 516 of the first hub node. Accordingly, with interleaving, each hub node transmits its DCH signals during the inactive period of the other network (or networks). If interleaving is possible, only a simple shift in time of the IBI is required in order to mitigate/avoid interference; this minimises the disruption to the operation of the first wireless network 110 and also keeps down the amount of energy spent on mitigating interference.

Criteria may be assessed at step S006 to determine if such interleaving is possible. As an example, the hub node 114 of the first wireless network 110 will check the duty cycling (%) of the other network for which it has received a CCH signal. If the duty cycling of the other network is in the range 75-100%, then interleaving is not preferable.

If the duty cycling is<75%, interleaving may be preferable if:
1. the first wireless network's inactive period is greater than the active period of the other network. In the case where there are multiple networks, then the first wireless network's inactive period should be greater than the sum of all the other network's active periods, and;
2. the first wireless network's IBI is an integer multiple of the other network's IBI; or
3. of the other network's IBI is an integer multiple of the first wireless network's IBI.

If it is determined at step S006 that interleaving cannot be performed, then the method proceeds to step S007. If it is determined at step S006 that interleaving can be performed, then the method proceeds to step S008.

At step S007, the hub node 114 checks to see if it is possible to adjust its own BAN parameters such that the conditions for interleaving of step S006 would be satisfied.

For example, the hub node 114 could change the active period of the first wireless network 110 and/or change its duty cycling and/or the duration of its IBI. If so, then the method will proceed to step S007′ and the hub node 114 will change its CCH parameters accordingly before proceeding to step S008. Otherwise, the method will proceed to step S009 so as change its DCH to avoid interference.

If the method arrives at step S008, then a determination has been made that interleaving is possible and so the hub node will change its active period so as to shift its D-Beacon in time, thereby aligning it with the inactive period of the other network. The method then ends at step S010.

Although the approaches described with reference to FIG. 4 have been explained in the context of a first wireless network and a single other wireless network, the approaches described herein could equally be employed in situations where a first wireless network and a plurality of other networks (i.e. BANs) are present—for example where the first wireless network is in close proximity to such a plurality of other networks. In such cases, at step S002, S003, and S004, the hub node 114 searches for C-Beacons from any of the plurality of other networks, reads those C-Beacons and, if none of the other networks is using the same DCH as the first wireless network, then the method proceeds to step S009. Similarly, at step S005 the hub node 114 only decides to proceed to step S005′ if none of the other networks have a mitigation bit set. The decisions and actions at steps S006, S007, S007′, and S008 are then made on the basis of the information about the DCHs of the other networks.

Although the above has described the steps of the flowchart of FIG. 4 being performed by the hub node 114, the method could equally be performed at another node of the first wireless network 110, or by a processor connected thereto. As a further possibility, different steps of the method could be performed by different components of the first wireless network.

There is described herein an approach for interference mitigation in a first wireless network, for example a Body Area Network (BAN), that uses signals from other BANs to adjust data transmissions by the first network.

Examples of the described approaches are set out in the below list of numbered clauses:
1. A method of avoiding interference in a body area network, comprising:
2. Configuring the control channel beacon to indicate the interference mitigation status of the body area network;
3. Configuring the control channel beacon to indicate the duty cycling of the body area network;
4. Shifting the active period in time to coexist with other networks;
5. Changing the duty cycling, inter-beacon interval, or active period duration based on surrounding networks;
6. Choosing the operating channel based on the duty cycling of neighbouring body area networks and the channel quality of the channel.

The approaches described herein may be performed entirely with a first network without any need for the first network to send out any communications, such as signalling, to another network.

The approaches described herein may be employed individually or in combination with the approaches described in the ETSI (European Telecommunications Standards Institute) TS 103 325“Smart Body Area Networks (SmartBAN); Low Complexity Medium Access Control (MAC) for SmartBAN” standard and the wireless networks 110, 124, 126, and the base station 122 may be arranged to operate in accordance with that standard.

It is foreseen, and disclosed, that any of the approaches described herein may be employed either alone or in any combination.

The approaches described herein may be embodied in any appropriate form including hardware, firmware, and/or software, for example on a computer readable medium, which may be a non-transitory computer readable medium. The computer readable medium carrying computer readable instructions arranged for execution upon a processor so as to make the processor carry out any or all of the methods described herein.

The term computer readable medium as used herein refers to any medium that stores data and/or instructions for causing a processor to operate in a specific manner. Such a storage medium may comprise non-volatile media and/or volatile media. Non-volatile media may include, for example, optical or magnetic disks. Volatile media may include dynamic memory. Exemplary forms of storage medium include, a floppy disk, a flexible disk, a hard disk, a solid state drive, a magnetic tape, any other magnetic data storage medium, a CD-ROM, any other optical data storage medium, any physical medium with one or more patterns of holes or protrusions, a RAM, a PROM, an EPROM, a FLASH-EPROM, NVRAM, and any other memory chip or cartridge.

1. A method for mitigating/avoiding interference with a first wireless network, the method comprising:
determining that a signal received in the first wireless network has experienced interference;
receiving a control channel signal for a second wireless network;
extracting, from the received control channel signal, information about a data channel used by the second wireless network; and
based on the information about the data channel used by the second wireless network, adjusting one or more parameters for a data channel used by the first wireless network.

2. The method of claim 1, further comprising transmitting, using a control channel signal for the first wireless network, the one or more adjusted parameters.

3. The method of claim 1 or 2, further comprising transmitting, using the one or more adjusted parameters, data on the data channel used by the first wireless network.

4. The method of any preceding claim, wherein at least one of the one or more parameters relate to one or more of the following:
the timing of an active period for the data channel of the first wireless network;
the duration of the active period for the data channel of the first wireless network;
the duty cycling for the data channel of the first wireless network; and
the inter-beacon interval for the data channel of the first wireless network.

5. A method for mitigating/avoiding interference with a first wireless network, the method comprising:
determining that a signal received in the first wireless network has experienced interference;
receiving a control channel signal for a second wireless network;
extracting an interference mitigation bit from the received control channel signal; and
if the interference mitigation bit indicates that interference mitigation is not being performed for the second wireless network, initiating an interference mitigation process for the first wireless network.

6. The method of claim 5, further comprising, if the interference mitigation bit indicates that interference mitigation is not being performed for the second wireless network, setting a mitigation bit for use in a control channel signal of the first wireless network, optionally further comprising sending the control channel signal of the first wireless network.

7. A method for mitigating/avoiding interference with a first wireless network, the method comprising the steps of:
determining that a signal received in the first wireless network has experienced interference;
receiving a control channel signal for a second wireless network;
extracting, from the received control channel signal, information about a data channel used by the second wireless network; and
if the data channel used by the second wireless network is not the same as a data channel used by the first wireless network, changing the data channel used by the first wireless network.

8. The method of claim 7, further comprising sending data within the first wireless network using the changed data channel.

9. The method of any preceding claim, wherein the determining that a signal received in the first wireless network has experienced interference is based on an assessment of one or more of: a packet error rate, a signal to noise ratio, and a received signal strength indicator.

10. The method of any preceding claim, wherein the method is performed within a Body Area Network.

11. An apparatus arranged to perform the method of any preceding claim.

12. A non-transitory computer readable medium comprising machine readable instructions arranged, when executed by one or more processors, to cause the one or more processors to carry out the method of any of claims 1 to 10.
